(19) United States
(12) Patent Application Publication
(10) Pub. No.: US 2024/0030988 A1
(43) Pub. Date: Jan. 25, 2024

(54) TERMINAL AND BASE STATION

(71) Applicant: NTT DOCOMO, INC., Tokyo (JP)

(72) Inventors: Wenjia Liu, Beijing (CN); Xiaolin Hou, Beijing (CN); Xin Wang, Beijing (CN); Yuki Matsumura, Tokyo (JP); Nadisanka Rupasinghe, Tokyo (JP)

(73) Assignee: NTT DOCOMO, INC., Tokyo (JP)

(21) Appl. No.: 18/268,505

(22) PCT Filed: Dec. 29, 2020
(86) PCT No.: PCT/CN2020/140956

§ 371 Date: Jun. 20, 2023

(51) Int. Cl. H04B 7/06

(52) U.S. Cl. CPC H04B 7/0639; H04B 7/0634

(57) ABSTRACT

The present disclosure provides a terminal and a base station. The terminal includes: a control unit, configured to determine at least one group of transform domain vectors, the at least one group of transform domain vectors being used for determining a precoding matrix for a subcarrier level, and a sending unit, configured to send precoding matrix indication information to a base station, the precoding matrix indication information including first information, the first information being used for indicating at least one group of transform domain vectors. The base station includes a receiving unit, configured to receive precoding matrix indication information from a terminal, the precoding matrix indication information at least including first information, the first information being used for indicating at least one group of transform domain vectors, and a control unit, configured to determine a precoding matrix according to the precoding matrix indication information.

### TECHNICAL FIELD

The present disclosure relates to the field of wireless communication, and more particularly to a method performed by a terminal in a communication system, a method performed by a base station in a communication system, and the corresponding terminal and base station.

### BACKGROUND

In order to improve the throughput of a communication system, a multi-antenna technology, such as Multiple Input Multiple Output (MIMO) technology, is provided. In the scenario of applying multi-antenna technology, in order to effectively eliminate multi-user interference, to increase system capacity, and to reduce the difficulty of signal processing for the receiver, it is provided to apply the precoding technology on the transmitter side. In order to support the precoding technique, a codebook is designed.

Release 15 (which can be referred to as R15 for short) of the 5G New Radio (NR) has designed two types of codebooks, i.e., the first type of codebook (Type I codebook) and the second type of codebook (Type II codebook) respectively. However, the above codebooks are designed for subbands, and thus, operations based on the above codebooks are subband-level operations. Specifically, the terminal determines a Precoding Matrix Indicator (PMI) and feeds back to the base station that the operations for the PMI are subband-level operations, or the operations (for example, compressing) performed by the terminal according to the subband-level information are subband-level operations, and the operations of the base station generating the precoding matrix according to the PMI are also the subband-level operations. The granularity of these operations is relatively low, which limits the performance of the communication system.

In order to improve the performance of the communication system, designing a codebook for subcarriers is provided. In the case that the communication system applies the subcarrier-level precoding technology, it is an aspect to be considered which information the terminal should be fed back to the base station such that the base station can determine the subcarrier-level pre coding matrix.

### SUMMARY OF THE DISCLOSURE

In order to overcome the defects in the prior art, the present disclosure provides a method performed by a terminal, a method performed by a base station, and the corresponding terminal and base station.

According to one aspect of the present disclosure, a method performed by a terminal is provided, comprising: determining at least one group of transform domain vectors, wherein the at least one group of transform domain vectors is used to process factors associated with a plurality of spatial domain vectors that are used to determine a subcarrier-level precoding matrix; and transmitting the precoding matrix indication information to a base station, wherein the precoding matrix indication information comprises first information that is used to indicate at least one group of transform domain vectors.

According to one example of the present disclosure, the above method further comprises: receiving indication information from the base station, which is used to indicate the number of the at least one group of transform domain vectors; wherein the determining the at least one group of transform domain vectors comprises: determining at least one group of transform domain vectors corresponding to the number.

According to one example of the present disclosure, wherein when the at least one group of transform domain vectors is one group of transform domain vectors that is used to process factors associated with each spatial domain vector of the plurality of spatial domain vectors.

According to one example of the present disclosure, wherein when the at least one group of transform domain vectors is a plurality of groups of transform domain vectors, the number of the plurality of groups of transform domain vectors is the same as the number of the plurality of spatial domain vectors, and each group of transform domain vectors of the plurality of groups of transform domain vectors is used to process the factors associated with respective spatial domain vectors of the plurality of spatial domain vectors, respectively.

According to one example of the present disclosure, wherein the first information is used to indicate an index of the at least one group of transform domain vectors.

According to one example of the present disclosure, wherein the precoding matrix indication information further comprises second information that is used to indicate a parameter for determining the at least one group of transform domain vectors.

According to one example of the present disclosure, wherein the parameter is used to determine the at least one group of transform domain vectors from the candidate transform domain vectors with respect to the precoding matrix.

According to one example of the present disclosure, wherein the parameter is a first parameter that represents the number of the candidate transform domain vectors with respect to the precoding matrix.

According to one example of the present disclosure, wherein the parameter is a second parameter that is used to determine the at least one group of transform domain vectors from a subset of the candidate transform domain vectors with respect to the precoding matrix.

According to another aspect of the present disclosure, a method performed by a base station is provided, comprising: receiving precoding matrix indication information from a terminal, wherein the precoding matrix indication information at least comprises first information that is used to indicate the at least one group of transform domain vectors, the at least one group of transform domain vectors is used to process factors associated with a plurality of spatial domain vectors that are used to determine a subcarrier-level precoding matric; determining the subcarrier-level precoding matrix according to the precoding matrix indication information.

According to another aspect of the present disclosure, a terminal is provided, comprising: a control unit configured to determine at least one group of transform domain vectors, wherein the at least one group of transform domain vectors is used to process factors associated with a plurality of spatial domain vectors that are used to determine the subcarrier-level precoding matrix; and a transmitting unit configured to transmit precoding matrix indication information to a base station, wherein the precoding matrix indication information comprises first information that is used to indicate the at least one group of transform domain vectors.

According to one example of the present disclosure, the above-mentioned terminal further comprises: a receiving unit, configured to receive indication information from the base station, which is used to indicate the number of the at least one group of transform domain vectors; wherein the control unit is configured to determine at least one group of transform domain vectors corresponding to the number.

According to one example of the present disclosure, wherein when the at least one group of transform domain vectors is one group of transform domain vectors that are used to process factors associated with each spatial domain vectors factor of the plurality of spatial domain vectors.

According to one example of the present disclosure, wherein when the at least one group of transform domain vectors is a plurality of groups of transform domain vectors, the number of the plurality of groups of transform domain vectors is the same as the number of the plurality of spatial domain vectors, and each group of transform domain vectors of the plurality of groups of the transform-domain vectors is used to process the factors associated with respective spatial domain vectors of the plurality of spatial-domain vectors, respectively.

According to one example of the present disclosure, wherein the first information is used to indicate an index of the at least one group of transform domain vectors.

According to one example of the present disclosure, wherein the precoding matrix indication information further comprises second information that is used to indicate a parameter for determining the at least one group of transform domain vectors.

According to one example of the present disclosure, wherein the parameter is used to determine the at least one group of transform domain vectors from the candidate transform domain vectors with respect to the precoding matrix.

According to one example of the present disclosure, wherein the parameter is a first parameter that represents the number of the candidate transform domain vectors with respect to the precoding matrix.

According to one example of the present disclosure, wherein the parameter is a second parameter that is used to determine the at least one group of transform domain vectors from a subset of the candidate transform domain vectors with respect to the precoding matrix.

According to another aspect of the present disclosure, a base station is provided, comprising: a receiving unit configured to receive precoding matrix indication information from a terminal, wherein the precoding matrix indication information at least includes first information that is used to indicate the at least one group of transform domain vectors, the at least one group of transform domain vectors is used to process factors associated with a plurality of spatial domain vectors, the plurality of spatial domain vectors are used to determine a subcarrier-level precoding matric; and a control unit configured to determine a the subcarrier-level precoding matrix according to the precoding matrix indication information.

The method performed by the terminal, the method performed by the base station, and the corresponding terminal and the base station according to the above aspects of the present disclosure, in the case that the communication system applies the subcarrier-level precoding technology, the terminal can determine at least one group of transform domain vectors that is used to process factors associated with the plurality of spatial domain vector, and comprise the at least one group of transform domain vectors in the precoding matrix indication information, and feed the precoding matrix indication information back to the base station such that the base station can determine the subcarrier-level precoding matrix according to the precoding matrix indication information.

### BRIEF DESCRIPTION OF THE DRAWINGS

The above and other objects, features and advantages of the present disclosure will become more apparent from the more detailed description of the embodiments of the present disclosure in connection with the accompanying drawings. The accompanying drawings are used to provide a further understanding of the embodiments of the present disclosure, and constitute a part of the specification, and are used to explain the present disclosure together with the embodiments of the present disclosure, and do not limit the present disclosure. In the drawings, the same reference numbers generally refer to the same components or steps.

FIG. 1 shows a schematic diagram of a wireless communication system in which embodiments of the present disclosure are applied.

FIG. 2 shows a flowchart of a method performed by a terminal according to an embodiment of the present disclosure.

FIG. 3 is a flowchart of a method of determining one group of transform domain vectors from the candidate transform domain vectors by a terminal according to an embodiment of the present disclosure.

FIG. 4 shows a flowchart of a method performed by a base station according to an embodiment of the present disclosure.

FIG. 5 shows a schematic structural diagram of a terminal according to an embodiment of the present disclosure.

FIG. 6 shows a schematic structural diagram of a base station according to an embodiment of the present disclosure.

FIG. 7 is a schematic diagram of a hardware structure of a communication device according to an embodiment of the present disclosure.

### DESCRIPTION OF THE EMBODIMENTS

In order to make the targets, technical solutions and advantages of the present disclosure more apparent, exemplary embodiments according to the present disclosure will be detailed below with reference to the accompanying drawings. In the drawings, the same reference numbers refer to the same elements throughout. It should be understood that the embodiments described herein are illustrative only and should not be construed as limiting the scope of the present disclosure.

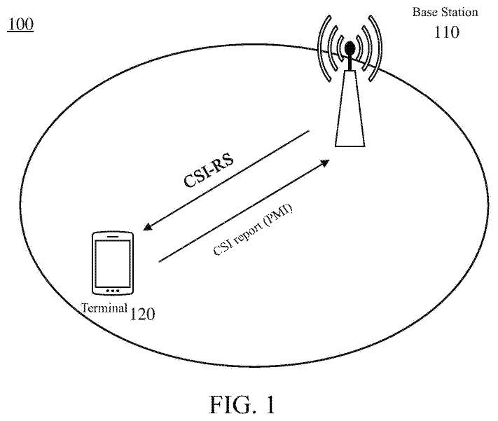

Firstly, a wireless communication system in which embodiments of the present disclosure can be applied is described with reference to FIG. 1. FIG. 1 shows a schematic diagram of a wireless communication system in which embodiments of the present disclosure can be applied. The wireless communication system 100 shown in FIG. 1 can be a 5G communication system, or can be any other type of wireless communication system, such as a 6G communication system. Hereinafter, the embodiments of the present disclosure are described by taking a 5G communication system as an example, but it should be appreciated that the following description can also be applied to other types of wireless communication systems.

As shown in FIG. 1, the wireless communication system 100 can include a base station 110 and a terminal 120, and the base station 110 is a serving base station of the terminal 120. The base station 110 can transmit a Channel State Information Reference Signal (CSI-RS) to the terminal 120. The terminal 120 can measure the CSI-RS, and determine the channel condition according to the measurement, and determine a Precoding Matrix Indicator (PMI). The terminal 120 can contain the PMI in the CSI report, and transmit the CSI report to the base station 110, thereby achieving feedback of the PMI to the base station 110. The base station 110 can generate a precoding matrix according to the PMI and the precoding matrix is then applied in downlink transmissions from the base station 110 to the terminal 120.

The base stations described herein can provide communication coverage for particular geographic areas, which can be referred to as cells, Node Bs, gNBs, 5G Node Bs, access points, and/or transmission reception points, among others. The terminals described herein can include various types of terminals, such as user equipment (UE), mobile terminals (or referred to as mobile stations) or fixed terminals, however, for convenience, sometimes terminals and UEs are used interchangeably hereinafter.

It should be recognized that although FIG. 1 only shows one base station and one terminal, the wireless communication system can include more base stations and/or more terminals, and one base station can serve multiple terminals, and one terminal can also be served by multiple base stations.

In the above-described process for the terminal to determine the PMI, the terminal uses the corresponding codebook according to the configuration. In the prior art, codebooks are designed for sub-bands of wireless communication systems, and accordingly, precoding techniques and/or CSI feedback are subband-level operations. The granularity of these operations is relatively low, which limits the performance of the communication systems.

In order to overcome the defects in the subband-level precoding technology and/or the CSI feedback technology, the subband-level precoding technology and/or CSI feedback technology have been provided to increase the granularity of operations, thereby improving the performance of the communication system. Specifically, the subcarrier-level precoding technique and/or CSI feedback can be implemented based on the existing enhanced second type of codebook. For example, the sub-band-related parameters and operations involved during the applying of the existing enhanced second-type codebook can be modified into the subcarrier-related parameters and operations, which can be referred to as enhanced Frequency Domain (eFD) compression scheme.

When the wireless communication system applies the subcarrier-level precoding technology and/or CSI feedback, it is an aspect to be considered which information the terminal should be fed back to the base station so that the base station can determine the subband-level precoding matrix.

The present disclosure provides that, in the case that the wireless communication system applies the subcarrier-level precoding technology and/or CSI feedback, the terminal can determine a plurality of spatial domain vectors and at least one group of transform domain vectors for each layer corresponding to the precoding process, in which the at least one group of transform domain vectors can be used to process factors associated with the plurality of spatial domain vectors (e.g., can be used to compress factors associated with the plurality of spatial domain vectors). The terminal can use the at least one group of transform domain vectors for processing factors associated with the plurality of spatial domain vectors to obtain processed factors. Then, the terminal can feed the information related to the determined plurality of spatial domain vectors, information related to the determined at least one group of transform domain vectors, and the processed factors, back to the base station. Accordingly, the base station can determine the subcarrier-level precoding matrix based at least on the information.

The transform domain described herein can be a domain resulting from transforming the frequency domain, such as a delay domain. The transform domain vectors can be Discrete Fourier Transform (DFT) vectors, and the factors can be frequency domain weighting coefficients (e.g., complex Linear Combination (LC) coefficients).

Specific implementations of the technical solutions of the present disclosure will be described below from the perspective of the terminal and the perspective of the base station.

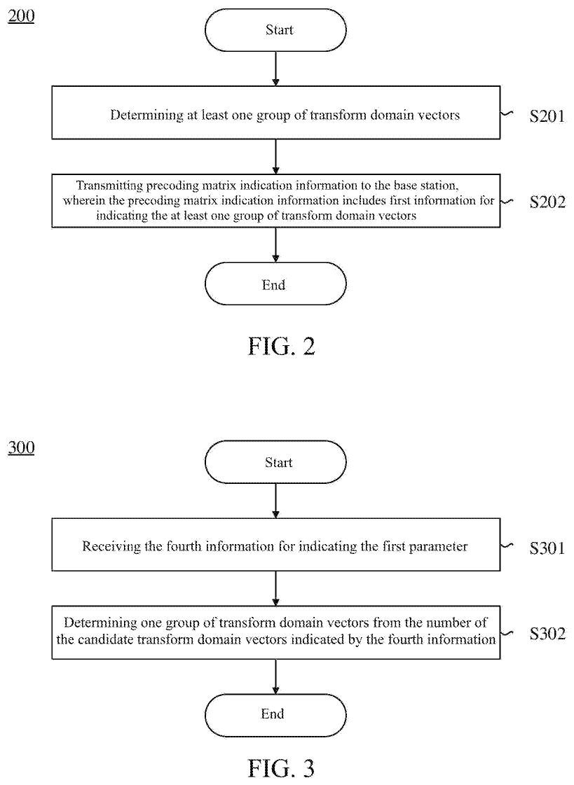

Firstly, a method performed by a terminal according to an embodiment of the present disclosure will be described in connection with FIG. 2. FIG. 2 shows a flowchart of a method 200 performed by the terminal according to an embodiment of the present disclosure. For each layer corresponding to the precoding process, the terminal can perform the method 200 respectively.

As shown in FIG. 2, in step S201, the terminal determines at least one group of transform domain vectors, in which the at least one group of transform domain vectors is used to process factors associated with a plurality of spatial domain vectors which is used to determine the subcarrier-level precoding matrix.

In the present disclosure, the subcarrier-level precoding matrix is different from the subband-level precoding matrix in the prior art. Specifically, in the prior art, the codebook for precoding technology and/or CSI feedback is a codebook designed for subbands, so the precoding matrix determined based on the codebook is subband-level precoding matrix. However, in the present disclosure, the codebook used for the precoding technique and/or CSI feedback is a codebook designed for subcarriers, so the precoding matrix determined based on the codebook is a subcarrier level precoding matrix. In the present disclosure, a precoding matrix at the subcarrier level can also be referred to as a precoding matrix for a subcarrier, or a precoding matrix for a subcarrier.

Before step S201, the terminal can determine a plurality of spatial domain vectors, for example, L spatial domain vectors, where L is a positive integer. The terminal can determine the plurality of spatial domain vectors according to a conventional method of determining spatial domain vectors (e.g., a method of determining spatial domain vectors specified by a wireless communication standard such as the 3GPP standard specification). In the present disclosure, the spatial domain vector can also be referred to as a spatial domain beam, a spatial domain codeword, a wideband codeword, a wideband spatial domain codeword, or the like.

In the present disclosure, each spatial domain vector can have frequency domain weighting coefficients, such as the LC coefficients mentioned above. The factors associated with the plurality of spatial domain vectors in step S201 can be frequency domain weighting coefficients of the plurality of spatial domain vectors.

In addition, the at least one group of transform domain vectors in step S201 can be one group of transform domain vectors, or can be a plurality of groups of transform domain vectors. The at least one group of transform domain vectors in step S201 is used to determine a subcarrier-level precoding matrix, specifically, to process factors associated with the plurality of spatial domain vectors.

In the present disclosure, the terminal can autonomously determine the number of the groups of transform domain vectors. For example, the terminal can determine how many groups of transform domain vectors that it should determine according to the provisions of a wireless communication standard (e.g., the 3GPP standard specification). For example, a wireless communication standard (e.g., the 3GPP standard specification) can specify that the number of the groups of transform domain vectors is one. Accordingly, in step S201, the terminal determines one group of transform domain vectors.

Alternatively, the terminal can determine the number of the groups of transform domain vectors by means of an indication from the base station. In this case, the base station can indicate to the terminal the number of the groups of transform domain vectors or a value range of the number of the groups of transform domain vectors.

For example, in an example where the base station indicates to the terminal the number of the groups of transform domain vectors, the method 200 can further comprise: the terminal receiving indication information, which is used to indicate the number of the at least one group of transform domain vectors, from the base station. In this example, in step S201, the terminal can determine at least one group of transform domain vectors corresponding to the number. For example, the number of the at least one group of transform domain vectors indicated by the indication information is one. Accordingly, in step S201, the terminal can determine one group of transform domain vectors. For another example, the number of the at least one group of transform domain vectors indicated by the indication information is L (i.e., the same as the number of the plurality of spatial domain vectors). Accordingly, in step S201, the terminal can determine L groups of transform domain vectors. For another example, the number of the at least one group of transform domain vectors indicated by the indication information is L/2. Accordingly, in step S201, the terminal can determine L/2 groups of transform domain vectors.

For another example, in an example where the base station indicates to the terminal the value range of the number of the groups of transform domain vectors, the method 200 can further comprise: the terminal receiving indication information, which is used to indicate the number of the at least one group of transform domain vectors is greater than or equal to the preset threshold, from the base station. When the indication information indicates that the number of the at least one group of transform domain vectors is greater than or equal to the preset threshold, the terminal can determine the plurality of groups of transform domain vectors. The number of the plurality of groups of transform domain vectors can be the same as the number of the plurality of spatial domain vectors, or can be greater than the number of the plurality of spatial domain vectors (e.g., twice the number of the plurality of spatial domain vectors). When the indication information indicates that the number of the at least one group of transform domain vectors is less than the preset threshold, the terminal can determine one group of transform domain vectors. For example, the preset threshold can be 2, and when the indication information indicates that the number of the at least one group of transform domain vectors is greater than or equal to 2, the terminal can determine L groups of transform domain vectors, and when the indication information indicates the number of the at least one group of transform domain vectors is less than 2, the terminal can determine one group of transform domain vectors.

In addition, according to an example of the present disclosure, for the indication information described above, the base station can transmit the indication information to the terminal via a higher layer signaling. In an example where the higher layer signaling is Radio Resource Control (RRC) signaling or Media Access Control (MAC) Control Element (CE), the base station can transmit the indication information to the terminal via the RRC signaling or the MAC CE. Accordingly, the terminal can receive the indication information from the base station via the RRC signaling or the MAC CE. Alternatively, the base station can transmit the indication information to the terminal via a lower layer signaling. In an example where the lower layer signaling is Downlink Control Information (DCI), the base station can transmit the indication information to the terminal via the DCI. Accordingly, the terminal can receive the indication information from the base station via the DCI.

In the present disclosure, when the at least one group of transform domain vectors is one group of transform domain vectors, the group of transform domain vectors is used to process the factors associated with each spatial domain vector of the plurality of spatial domain vectors. For example, in an example where the factors are frequency domain weighting coefficients and the processing is compressing, the group of transform domain vectors can be used to compress the frequency domain weighting coefficients for each spatial domain vector of the plurality of spatial domain vectors. That is, for each spatial domain vector of the plurality of spatial domain vectors, the group of transform domain vectors is common.

In addition, when the at least one group of transform domain vectors is a plurality of groups of transform domain vectors, the number of the plurality of groups of transform domain vectors can be the same as the number of the plurality of spatial domain vectors, and each group of transform domain vectors of the plurality of groups of transform domain vectors is respectively used to process factors associated with the respective spatial domain vectors of the plurality of spatial domain vectors. For example, in an example where the factors are frequency domain weighting coefficients and the processing is compressing, each group of transform domain vectors of the plurality of groups of transform-domain vectors is respectively used to compress the frequency-domain weighted of the respective spatial domain vectors of the plurality of spatial domain vectors. For example, the number of groups of transform domain vectors can be L, and the plurality of groups of transform domain vectors are respectively a first group of transform domain vectors, a second group of transform domain vectors, . . . , and an Lth group of transform domain vectors, and the first group of transform domain vectors is used to compress the frequency domain weighting coefficients of the first spatial domain vector of the plurality of spatial domain vectors, the second group of transform domain vectors is used to compress the frequency domain weighting coefficients of the second spatial domain vector of the plurality of spatial domain vectors, . . . , and the Lth group of transform domain vectors is used to compress the frequency domain weighting coefficients of the Lth spatial domain vector of the plurality of spatial domain vectors. That is, for each spatial domain vector of the plurality of spatial domain vectors, the group of transform domain vectors is specific. This circumstance is applicable to the situation where the base station adopts a single-polarized antenna or the situation where the base station adopts a dual-polarized antenna and the two polarization directions of the dual-polarized antenna use the same group of transform domain vectors.

Furthermore, when the at least one group of transform domain vectors is the plurality of groups of transform domain vectors, the number of the plurality of groups of transform domain vectors can be greater than the number of the plurality of spatial domain vectors, and each group of transform domain vectors of the plurality of groups of transform domain vectors is respectively used to process factors in each polarization direction associated with the respective spatial domain vectors of the plurality of spatial domain vectors. For example, the number of the plurality of groups of transform domain vectors can be twice the number of the plurality of spatial domain vectors. For example, in an example where the factors are frequency domain weighting coefficients and the processing is compressing, each group of transform domain vectors of the plurality of groups of transform domain vectors is respectively used to compress the frequency domain weighting coefficients in each polarization direction of the respective spatial domain vector of the plurality of spatial domain vectors. For example, the number of the plurality of groups of transform domain vectors can be 2L, and the plurality of groups of transform domain vectors are respectively a first group of transform domain vectors, a second group of transform domain vectors, . . . , and a 2Lth group of transform domain vectors, and the first group of transform domain vectors is used to compress the frequency domain weighting coefficient in the first polarization direction of the first spatial domain vector of the plurality of spatial domain vectors, the second group of transform domain vectors is used to compress the frequency domain weighting coefficient in the second polarization direction of the first spatial domain vector of the plurality of spatial domain vectors, the third group of transform domain vectors is used to compress the frequency domain weighting coefficientin the first polarization direction of the second spatial domain vector of the plurality of spatial domain vectors, the fourth group of transform domain vectors is used to compress the frequency domain weighting coefficient in the second polarization direction of the second spatial domain vector od the plurality of spatial domain vectors, . . . , the (2L−1)th group of transform domain vectors is used to compress the frequency domain weighting coefficient in the first polarization direction of the Lth spatial domain vector of the plurality of spatial domain vectors, and the 2L group of transform domain vectors is used to compress the frequency domain weighting coefficient in the second polarization direction of the Lth spatial domain vector of the plurality of spatial domain vectors. This circumstance is applicable to the situation where the base station adopts a dual-polarized antenna and the two polarization directions of the dual-polarized antenna use different groups of transform domain vectors.

Furthermore, when the at least one group of transform domain vectors is a plurality of groups of transform domain vectors, the number of the plurality of groups of transform domain vectors can be smaller than the number of the plurality of spatial domain vectors, and the number of the plurality of spatial domain vectors can be an integer multiple of the number of the plurality of groups of transform domain vectors (or the number of the plurality of groups of transform domain vectors is divisible by the number of the plurality of spatial domain vectors). For example, the number of the plurality of spatial domain vectors can be L, and the number of the plurality of groups of transform domain vectors can be L/M, where L/M is a positive integer, and M is a positive integer greater than 1 and less than L. In this case, each group of transform domain vectors of the plurality of groups of transform domain vectors can be respectively used to process factors associated with the M spatial domain vectors of the plurality of spatial domain vectors. That is, every M spatial domain vectors can use the same group of transform domain vectors. For example, in an example where the factors are frequency domain weighting coefficients and the processing is compressing, each group of transform domain vectors of the plurality of groups of transform domain vectors is respectively used to compress the frequency domain weighting coefficients of M spatial domain vectors of the plurality of spatial domain vectors. For example, the number of the plurality of groups of transform domain vectors can be L/M, and the plurality of groups of transform domain vectors are respectively a first group of transform domain vectors, a second group of transform domain vectors, . . . , an L/Mth group of transform domain vectors, and the first group of transform domain vectors is used to compress the frequency domain weighting coefficient of the first spatial domain vector to the Mth spatial domain vector of the plurality of spatial domain vectors, the second group of transform domain vectors is used to compress the frequency domain weighting coefficients of the (M+1)th to the (2M)th spatial-domain vectors of the plurality of spatial domain vectors, . . . , the L/Mth group of transform-domain vectors is used to compress the frequency domain weighting coefficient of the (L−M+1)th spatial domain vectors to the Lth spatial domain vector of the plurality of spatial domain vectors.

Returning to FIG. 2, in step S201, the terminal can determine the at least one group of transform domain vectors from the candidate transform domain vectors related to the precoding matrix. Each group of transform domain vectors can include a plurality of transform domain vectors. For example, each group of transform domain vectors can include Mᵥ transform domain vectors, where Mᵥ is a positive integer, v represents a rank corresponding to the terminal and is a positive integer.

The following will describe a schematic flow where the terminal determines one group of transform domain vectors from the candidate transform domain vectors in connection with FIG. 3. FIG. 3 is a flowchart of a method for the terminal to determine one group of transform domain vectors from the candidate transform domain vectors according to an embodiment of the present disclosure. As shown in FIG. 3, in step S301, the terminal can receive fourth information for indicating a first parameter from the base station, where the first parameter represents the number of the candidate transform domain vectors with respect to the subcarrier-level precoding matrix.

According to an example of the present disclosure, the fourth information in step S301 can include the first parameter. For example, the fourth information can include only the first parameter, i.e., the fourth information is the first parameter. For another example, the fourth information can include not only the first parameter, but also other information (for example, other configuration information transmitted by the base station to the terminal).

In addition, according to an example of the present disclosure, the fourth information in step S301 can also be used to indicate the value range of the first parameter. In this example, the terminal can determine the value range of the first parameter according to the fourth information, and select a value from the value range, and use the selected value as the value of the first parameter.

In addition, the first parameter in step S301 can be represented as Mₘₐₓ, of which the value is smaller than the number of sub-carriers of the communication system (for example, it can be represented as N₃) and greater than the number of subbands of the communication system (for example, it can be represented as N₀). Alternatively, the value of the first parameter in step S301 can be smaller than the number (N₃) of subcarriers of the communication system and smaller than or equal to the number (N₀) of subbands of the communication system.

In addition, the base station can transmit the fourth information to the terminal via higher layer signaling. In an example where the higher layer signaling is Radio Resource Control (RRC) signaling or Media Access Control (MAC) Control Element (CE), the base station can transmit the fourth information to the terminal via the RRC signaling or the MAC CE. Accordingly, in step S301, the terminal can receive the fourth information from the base station via RRC signaling or MAC CE.

In addition, the base station can transmit the fourth information to the terminal via lower layer signaling. In an example where the lower layer signaling is Downlink Control Information (DCI), the base station can transmit the fourth information to the terminal via the DCI. Accordingly, in step S301, the terminal can receive the fourth information from the base station via the DCI.

Then, in step S302, the terminal can determine one group of transform domain vectors from the number of the candidate transform domain vectors indicated by the fourth information. The group of transform domain vectors includes a plurality of transform domain vectors, for example, includes Mᵥ transform domain vectors, where Mᵥ is a positive integer, and v represents a rank corresponding to the terminal and is a positive integer.

When the value of the first parameter indicated by the fourth information is relatively small, that is, when the number (Mₘₐₓ) of the candidate transform domain vectors with respect to the subcarrier-level precoding matrix is relatively small, the terminal can directly select Mᵥ candidate transform domain vectors from Mₘₐₓ, candidate transform domain vectors. When the value of the first parameter indicated by the fourth information is relatively large, that is, when the number (Mₘₐₓ) of the candidate transform domain vectors with respect to the subcarrier-level precoding matrix is relatively large, the terminal can determine the Intermediate subset of the candidate transform domain vectors (which can be referred to as InS or a subset for short), and Mᵥ transform domain vectors are selected from the subset to further reduce the feedback overhead.

In the example where the terminal selects Mᵥ transform domain vectors from the subset, the terminal can determine at least one group of transform domain vectors from the subset of the candidate transform domain vectors with respect to the subcarrier-level precoding matrix according at least to the second parameter. When the at least one group of transform domain vectors is one group of transform domain vectors and the group of transform domain vectors includes Mᵥ transform domain vectors, the terminal can determine Mᵥ transform domain vectors from the subset of the candidate transform domain vectors with respect to the subcarrier-level precoding matrix according to the second parameter. The second parameter can be a parameter for determining the vectors included in the subset of the candidate transform domain vectors, which can be referred to as Mᵢₙᵢₜᵢₐₗ. The value range of the second parameter can be specified by a wireless communication standard specification (e.g., a 3GPP standard specification). For example, the value range of the second parameter can be: Mᵢₙᵢₜᵢₐₗ∈{−N₃′+1,−N₃′+2, . . . ,0}, where N₃′ represents the number of the vectors included in the subset (InS) of the candidate transform domain vectors (also referred as to the size of the subset).

The terminal and the base station can negotiate the value of the third parameter (N₃′) and the value of the fourth parameter (Mᵢₙᵢₜᵢₐₗ) in advance. According to a first example of the present disclosure, the terminal can determine the value of the third parameter and the value of the fourth parameter, and report the value of the third parameter and the value of the fourth parameter determined by itself to the base station. According to a second example of the present disclosure, the base station can determine the value of the third parameter and the value of the fourth parameter, and inform the terminal of the value of the third parameter and the value of the fourth parameter determined by itself. According to a third example of the present disclosure, the terminal can determine the value of the third parameter and report the value of the third parameter determined by itself to the base station, and the base station can determine the value of the fourth parameter and inform the terminal of the value of the fourth parameter determined by itself to the terminal. According to a fourth example of the present disclosure, the base station can determine the value of the third parameter and inform the terminal of the value of the third parameter determined by itself, and the terminal can determine the value of the fourth parameter and report the value of the fourth parameter determined by itself to the base station.

Returning to FIG. 2, in step S202, the terminal transmits precoding matrix indication information to the base station. In the present disclosure, the precoding matrix indication information is subcarrier-level precoding matrix indication information, which can also be referred to as precoding matrix indication information for subcarriers, or precoding matrix indication information directed to subcarriers. In addition, the precoding matrix indication information includes first information which is used to indicate the at least one group of transform domain vectors. For example, the first information can be used to indicate the indexes of the at least one group of transform domain vectors. For example, for any groups of transform domain vectors selected from the candidate transform domain vectors, an index can be preset. Accordingly, when the terminal determines at least one group of transform domain vectors in step S201, the first information in step S202 can indicate indexes of the at least one group of transform domain vectors.

In addition, according to an example of the present disclosure, the precoding matrix indication information in step S202 can further include second information. The second information can be used to indicate parameter used to determine the at least one group of transform domain vectors. The parameter is used to determine the at least one group of transform domain vectors from the candidate transform domain vectors with respect to the precoding matrix. For example, the parameter can be the first parameter (Mₘₐₓ) described above, which represents the number of the candidate transform domain vectors with respect to the precoding matrix. For another example, the parameter can be the second parameter (Mᵢₙᵢₜᵢₐₗ) described above, which is used to determine the at least one group of transform domain vectors from the subset of the candidate transform domain vectors with respect to the precoding matrix.

In addition, according to an example of the present disclosure, the precoding matrix indication information in step S202 can further include third information. The third information can be used to indicate the plurality of spatial domain vectors mentioned in step S201. For example, the third information can be used to indicate the indexes of the plurality of spatial domain vectors mentioned in step S201.

Furthermore, as described above, the terminal can use the at least one group of transform domain vectors to process the factors associated with the plurality of spatial domain vectors to obtain processed factors. According to an example of the present disclosure, the precoding matrix indication information in step S202 can further include the processed factors. In an example where the factors are frequency domain weighting coefficients and the processing is compressing, the precoding matrix indication information in step S202 can further include the compressed frequency-domain weighting coefficients.

Furthermore, as described above, the terminal can determine a plurality of spatial domain vectors and at least one group of transform domain vectors for each layer corresponding to the precoding process. When the value of the rank corresponding to the terminal is 1, the layer(s) corresponding to the precoding process is one layer (that is, the number of layers can be the same as the value of the rank), therefore, the terminal can determine the plurality of spatial domain vectors and the at least one group of transform domain vectors for the layer. Accordingly, the precoding matrix indication information in step S202 can include first information and second information corresponding to the at least one group of transform domain vectors, and third information corresponding to the plurality of spatial domain vectors. When the value of the rank corresponding to the terminal is greater than 1, the layer(s) corresponding to the precoding process includes a plurality of layers (the number of the plurality of layers can be the same as the value of the rank), therefore, the terminal can determine the plurality of spatial domain vectors and the at least one group of transform domain vectors for each layer respectively. Accordingly, the precoding matrix indication information in step S202 can include first information and second information corresponding to the at least one group of transform domain vectors for each layer, and third information corresponding to the plurality of spatial domain vectors for each layer. That is, the precoding matrix indication information in step S202 can include a plurality of pieces of first information, a plurality of second information, and a plurality of third information. In addition, according to an example of the present disclosure, the plurality of spatial domain vectors determined by the terminal for each layer can be the same. In this case, the precoding matrix indication information in step S202 can include a plurality of first information, a plurality of second information and one third information.

In addition, in an example where the terminal determines at least one group of transform domain vectors from a subset of the candidate transform domain vectors, when the terminal determines at least one group of transform domain vectors for different layers respectively, the terminal can determine different subsets according to different values of the second parameter, thereby determining at least one group of transform domain vectors for each layer from the different subsets. For example, when the terminal is set to determine at least one group of transform domain vectors for the first layer and the second layer respectively, the terminal can determine a first subset according to the first value of the second parameter, and determine the at least one group of transform domain vectors for the first layer from the first subset, and can determine a second subset according to the second value of the second parameter, and determine the at least one group of transform domain vectors for the second layer from the second subset.

Furthermore, in addition to the above-mentioned first information, second information, third information, and so forth, the precoding matrix indication information in step S202 can also include other information. Such information can be information specified by a wireless communication standard (e.g., 3GPP standard specification), for example, amplitude coefficient indicators, phase coefficient indicators for each layer, among others.

According to an example of the present disclosure, the precoding matrix indication information in step S202 can be a Precoding Matrix Indicator (PMI). A specific example of PMI is given below. The value of PMI can correspond to codebook indexes i₁ and i₂, where

$${i}_{1} = \{ \begin{matrix}[ {i}_{1 , 1} {i}_{1 , 2} {i}_{1 , 5} {i}_{1 , 6 , 1} {i}_{1 , 7 , 1} {i}_{1 , 8 , 1} ] & v = 1 \\ [ {i}_{1 , 1} {i}_{1 , 2} {i}_{1 , 5} {i}_{1 , 6 , 1} {i}_{1 , 7 , 1} {i}_{1 , 8 , 1} … {i}_{1 , 6 , v} {i}_{1 , 7 , v} {i}_{1 , 8 , v} ] & v > 1\end{matrix}$$

$${i}_{2} = \{ \begin{matrix}[ {i}_{2 , 3 , 1} {i}_{2 , 4 , 1} {i}_{2 , 5 , 1} ] & v = 1 \\ [ {i}_{2 , 3 , 1} {i}_{2 , 4 , 1} {i}_{2 , 5 , 1} … {i}_{2 , 3 , v} {i}_{2 , 4 , v} {i}_{2 , 5 , v} ] & v > 1\end{matrix}$$

wherein, i_{1,1} and i_{1,2} indicate the indexes of the plurality of spatial domain vectors, and i_{1,5} indicates at least one value of the first parameter (Mₘₐₓ) and/or at least one value of the second parameter (Mᵢₙᵢₜᵢₐₗ) (alternatively, indicates the index of at least one value of the first parameter and/or the index of at least one value of the second parameter), i_{1,6,l} indicates the index of the at least one group of transform domain vectors for the lth layer, where 1≤l≤v and l is a positive integer, v is the rank corresponding to the terminal and is a positive integer greater than or equal to 1. The definition of the remaining elements can follow the provisions of the wireless communication standard, for example, i_{2,3,l} and i_{2,4,l} can be the amplitude coefficient indicators for the lth layer, and i_{2,5,l} can be the phase coefficient indicator for the lth layer.

When the terminal determines one group of transform domain vectors for each layer, the value of the first parameter (Mₘₐₓ) and/or the value of the second parameter (Undid) for each layer can be the same or different. When the value of the first parameter and/or the value of the second parameter for each layer are the same, i_{1,5} can indicate one value of the first parameter and/or one value of the second parameter. Alternatively, when the value of the first parameter and/or the value of the second parameter for each layer are different, i_{1,5} can indicate the value of the first parameter and/or the value of the second parameter for each layer, that is, i_{1,5} can indicate a plurality of values of the first parameter (the number of the plurality of values can be the same as the number of layers, i.e., the same as the value of the rank) and/or a plurality of values of the second parameter (the number of the plurality of values can be the same as the number of layers, i.e., the same as the value of the rank).

If the terminal is required to report the value of the first parameter and/or the value of the second parameter to the base station, the terminal can report through i_{1,5}. In this case, i_{1,5} can be a vector. For example, i_{1,5} can be expressed as: i_{1,5}=[i_{1,5,1}, . . . , i_{1,5,l}, . . . ,i_{1,5,v}], wherein, 1≤l≤v and l is a positive integer, i_{1,5,l} represents the index of at least one value of the first parameter (Mₘₐₓ) corresponding to the lth layer and/or the index of at least one value of the second parameter (Mᵢₙᵢₜᵢₐₗ) corresponding to the lth layer. In the case of “for each spatial domain vectors of the plurality of spatial domain vectors, the group of transform domain vectors is common” described above, i_{1,5,l} can represent an index of one value of the first parameter (Mₘₐₓ) corresponding to the lth layer and/or an index of one value of the second parameter (Mᵢₙᵢₜᵢₐₗ) corresponding to the lth layer. Furthermore, in the case of “for each spatial domain vector of the plurality of spatial domain vectors, the group of transform domain vectors is specific” described above, when the at least one group of transform domain vectors for the lth layer are L groups of transform domain vectors, in order to determine L groups of transform domain vectors, the terminal can use L values of the first parameter (Mₘₐₓ) and/or L values of the second parameter (Mᵢₙᵢₜᵢₐₗ). In this case, i_{1,5,l} can indicate L values of the first parameter (Mₘₐₓ) and/or L values of the second parameter (Mᵢₙᵢₜᵢₐₗ) (alternatively, indicate indexes of L values of the first parameter and/or indexes of the L values of the second parameter). For example, i_{1,5,l} can be expressed as:

$${i}_{1 , 5 , l} = [ {k}_{l , 0}^{( 4 )} , … , {k}_{l , m}^{( 4 )} , … , {k}_{l , L - 1}^{( 4 )} ] ,$$

where 0≤m≤(L−1) and m is a positive integer, k_{l,m}⁽⁴⁾ indicates an index of the value of the first parameter (Mₘₐₓ) corresponding to the mth spatial domain vector of the lth layer and/or an index of the value of the second parameter (Mᵢₙᵢₜᵢₐₗ) corresponding to the mth spatial vector of the lth layer.

Furthermore, in the case of “for each spatial domain vector of the plurality of spatial domain vectors, the group of transform domain vectors is common”, i_{1,6,l} can represent an index of one group of transform domain vectors corresponding to the lth layer. In the case of “for each spatial domain vector of the plurality of spatial domain vectors, the set of transform domain vectors is specific”, when the at least one group of transform domain vectors for the lth layer is L groups of transform domain vectors, i_{1,6,l} can indicate the indexes of the L groups of transform domain vectors corresponding to the lth layer. In this case, i_{1,6,l} can be a vector. For example, i_{1,6,l} can be represented as:

$${i}_{1 , 6 , l} = [ {k}_{l , 0}^{( 5 )} , … , {k}_{l , m}^{( 5 )} , … , {k}_{l , L - 1}^{( 5 )} ] ,$$

where 0≤m≤(L−1) and m is a positive integer, k_{l,m}⁽⁵⁾ indicates an index of one group of transform domain vectors corresponding to the mth spatial domain vector of the lth layer.

In addition, in the present disclosure, “the candidate transform domain vectors with respect to the subcarrier-level precoding matrix” can be candidate transform domain vectors with respect to the subcarrier-level precoding matrix indication information (e.g., subcarrier-level PMI). The above described “the transform domain vectors which are used to determine a subcarrier-level precoding matrix” can be transform domain vectors used to determine subcarrier-level precoding matrix indication information (e.g., sub carrier-level PMI). The “at least one group of transform domain vectors” described above can be at least one group of transform domains used to determine subcarrier-level precoding matrix indication information (e.g., subcarrier-level PMI) or at least one group of transform domain vectors of the subcarrier-level precoding matrices. The “a plurality of spatial vectors” described above can be a plurality of spatial vectors used to determine subcarrier-level precoding matrix indication information (e.g., subcarrier-level PMI). With the method performed by the terminal according to the embodiment of the present disclosure, in the case where the communication system applies the subcarrier-level precoding technology, the terminal can determine at least one group of transform domain vectors for processing factors associated with the plurality of spatial domain vectors, and include the at least one group of transform domain vectors in the precoding matrix indication information, and feed the precoding matrix indication information back to the base station, so that the base station determines the subcarrier-level precoding matrix according to the precoding matrix indication information.

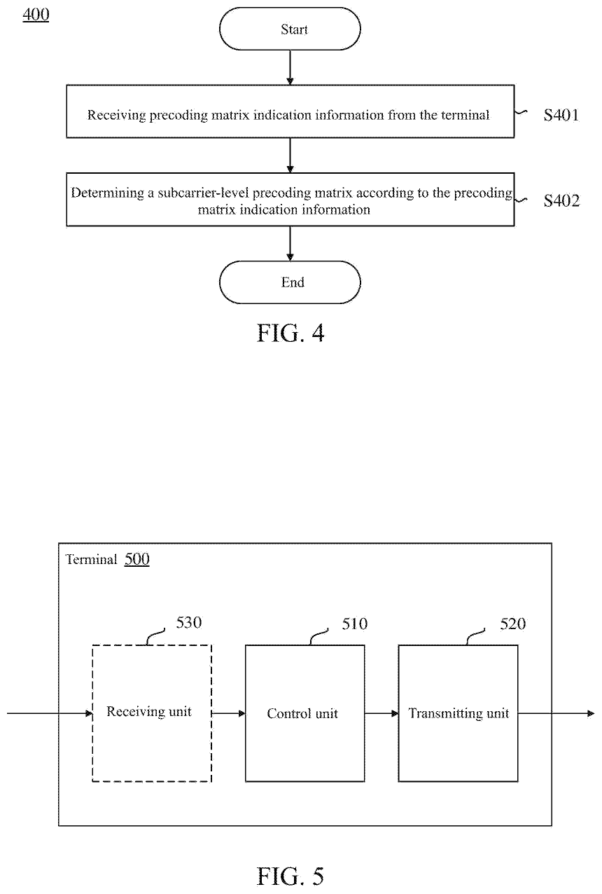

Hereinafter, a method performed by the base station according to an embodiment of the present disclosure will be described with reference to FIG. 4. FIG. 4 shows a flowchart of a method performed by the base station according to an embodiment of the present disclosure. Since some details of the method 400 are the same as those of the method 200 described above with reference to FIG. 2, and therefore, a detailed description of the same is omitted for simplicity.

As shown in FIG. 4, in step S401, the base station receives precoding matrix indication information from the terminal, in which the precoding matrix indication information at least includes first information that is used to indicate the at least one group of transform domain vectors, the at least one group of transform domain vectors is used to process factors associated with the plurality of spatial domain vectors, the plurality of spatial domain vectors are used to determine subcarrier-level precoding matrices.

In the present disclosure, the at least one group of transform domain vectors in step S401 can be one group of transform domain vectors, or can be a plurality of groups of transform domain vectors. The base station can indicate to the terminal the number of the groups of transform domain vectors or the value range of the number of the groups of transform domain vectors, so that the terminal can determine how many groups of transform domain vectors it should determine by means of indication of the base station.

For example, in an example where the base station indicates the number of the groups of transform domain vectors to the terminal, method 400 can further include: the base station transmits indication information to the terminal that is used to indicate the number of the at least one group of transform domain vectors. In this example, the terminal can determine at least one group of transform domain vectors corresponding to the number. For example, the number of the at least one group of transform domain vectors indicated by the indication information is one, and accordingly, the terminal can determine one group of transform domain vectors. For another example, the number of the at least one group of transform domain vectors indicated by the indication information is L (i.e., the same as the number of the plurality of spatial domain vectors), and accordingly, the terminal can determine L groups of transform domain vectors. For another example, the number of the at least one group of transform domain vectors indicated by the indication information is L/2, and accordingly, the terminal can determine L/2 groups of transform domain vectors.

For another example, in an example where the base station indicates to the terminal the value range of the number of the groups of transform domain vectors, the method 400 can further include: the base station transmits indication information to the terminal that is used to indicate the number of the at least one group of transform domain vectors is greater than the preset threshold. When the indication information indicates that the number of the at least one group of transform domain vectors is greater than the preset threshold, the terminal can determine a plurality of groups of transform domain vectors. The number of the groups of transform domain vectors can be the same as the number of the spatial domain vectors, or can be greater than the number of the spatial domain vectors (e.g., twice the number of the spatial domain vectors). When the indication information indicates that the number of the at least one group of transform domain vectors is less than the preset threshold, the terminal can determine one group of transform domain vectors. For example, the preset threshold can be 2, and when the indication information indicates that the number of the at least one group of transform domain vectors is greater than 2, the terminal can determine L groups of transform domain vectors, and when the indication information indicates the number of the at least one group of transform domain vectors is less than 2, the terminal can determine one group of transform domain vectors.

In addition, according to an example of the present disclosure, for the indication information described above, the base station can transmit the indication information to the terminal via higher layer signaling. In an example where the higher layer signaling is RRC signaling or MAC CE, the base station can transmit the indication information to the terminal via RRC signaling or MAC CE. Accordingly, the terminal can receive the indication information from the base station via RRC signaling or MAC CE. Alternatively, the base station can transmit the indication information to the terminal via lower layer signaling. In an example where the lower layer signaling is DCI, the base station can transmit the indication information to the terminal via DCI. Accordingly, the terminal can receive the indication information from the base station via DCI.

In addition, according to an example of the present disclosure, the precoding matrix indication information in step S401 can further include second information. The second information can be used to indicate parameter used to determine the at least one group of transform domain vectors. The parameter is used to determine the at least one group of transform domain vectors from candidate transform domain vectors with respect to the precoding matrix. For example, the parameter can be a first parameter (Mₘₐₓ) described above, which represents the number of the candidate transform domain vectors with respect to the precoding matrix. As another example, the parameter can be a second parameter (Mᵢₙᵢₜᵢₐₗ) described above for determining the at least one group of transform domain vectors from a subset of the candidate transform domain vectors with respect to the precoding matrix.

In addition, according to an example of the present disclosure, the precoding matrix indication information in step S401 can further include third information. The third information can be used to indicate a plurality of spatial domain vectors determined by the terminal. For example, the third information can be used to indicate indexes of the plurality of spatial domain vectors determined by the terminal.

Furthermore, as described above, the terminal can process the factors associated with the plurality of spatial domain vectors using at least one group of transform domain vectors to obtain processed factors. According to an example of the present disclosure, the precoding matrix indication information in step S401 can further include the processed factors. In an example where the factors are frequency domain weighting coefficients and the processing is compressing, the precoding matrix indication information in step S401 can further include the compressed frequency domain weighting coefficients.

Further, in addition to the first information, second information, third information, and so forth mentioned above, the precoding matrix indication information in step S401 can also include other information. Such information can be information specified by a wireless communication standard (e.g., 3 GPP standard specification), for example, amplitude coefficient indicators, phase coefficient indicators, and so forth for each layer.

According to an example of the present disclosure, the precoding matrix indication information in step S401 can be a Precoding Matrix Indicator (PMI). A specific example of PMI is given below. The value of PMI can correspond to indexes i₁ and i₂ of codebook, where

$${i}_{1} = \{ \begin{matrix}[ {i}_{1 , 1} {i}_{1 , 2} {i}_{1 , 5} {i}_{1 , 6 , 1} {i}_{1 , 7 , 1} {i}_{1 , 8 , 1} ] & v = 1 \\ [ {i}_{1 , 1} {i}_{1 , 2} {i}_{1 , 5} {i}_{1 , 6 , 1} {i}_{1 , 7 , 1} {i}_{1 , 8 , 1} … {i}_{1 , 6 , v} {i}_{1 , 7 , v} {i}_{1 , 8 , v} ] & v > 1\end{matrix}$$

$${i}_{2} = \{ \begin{matrix}[ {i}_{2 , 3 , 1} {i}_{2 , 4 , 1} {i}_{2 , 5 , 1} ] & v = 1 \\ [ {i}_{2 , 3 , 1} {i}_{2 , 4 , 1} {i}_{2 , 5 , 1} … {i}_{2 , 3 , v} {i}_{2 , 4 , v} {i}_{2 , 5 , v} ] & v > 1\end{matrix}$$

wherein, i_{1,1} and i_{1,2} indicate the indexes of the plurality of spatial domain vectors, and i_{1,5} indicates at least one value of the first parameter (Mₘₐₓ) and/or at least one value of the second parameter (Mᵢₙᵢₜᵢₐₗ) (alternatively, indicating the index of the at least one value of the first parameter and/or the index of the at least one value of the second parameter), i_{1,6,l} indicates the index of at least one group of transform domain vectors for the lth layer, 1≤l≤v and l is a positive integer, v is the rank corresponding to the terminal and is a positive integer greater than or equal to 1. The definition of the remaining elements can follow the provisions of the wireless communication standard, for example, i_{2,3,l} and i_{2,4,l} can be the amplitude coefficient indicators for the lth layer, and i_{2,5,l} can be the phase coefficient indicator for the lth layer.

Returning to FIG. 4, in step S402, the base station determines a subcarrier-level precoding matrix according to the precoding matrix indication information. For example, in an example where the precoding matrix indication information is PMI, the base station can generate the precoding matrix according to a conventional manner of generating a precoding matrix through PMI (e.g., the manner specified by the 3GPP standard specification).

With the method performed by the base station in the embodiment of the present disclosure, in the case where the communication system applies the subcarrier-level precoding technology, the terminal can determine at least one group of transform domain vectors for processing factors associated with a plurality of spatial domain vectors, and include the at least one group of transform domain vectors in the precoding matrix indication information, and feed the precoding matrix indication information back to the base station, accordingly, the base station can receive the precoding matrix indication information from the terminal and determine the subcarrier-level precoding matrix according to the precoding matrix indication information.

Hereinafter, a terminal according to an embodiment of the present disclosure will be described with reference to FIG. 5. FIG. 5 is a schematic structural diagram of a terminal 500 according to an embodiment of the present disclosure. Since the functions of the terminal 500 are the same as some details of the method 200 described above with reference to FIG. 2, detailed descriptions of the same are omitted for simplicity. As shown in FIG. 5, the terminal 500 includes a control unit 510 configured to determine at least one group of transform domain vectors, where the at least one group of transform domain vectors is used to process factors associated with a plurality of spatial domain vectors, the plurality of spatial domain vectors are used to determine subcarrier-level precoding matrix and a transmitting unit 520 configured to transmit precoding matrix indication information to the base station, where the precoding matrix indication information includes first information that is used to indicate the at least one group of transform domain vectors. In addition to the two units, the terminal 500 can further include other components, however, since these components are irrelevant to the contents of the embodiments of the present disclosure, their illustrations and descriptions are omitted here.

In the present disclosure, for each layer corresponding to the precoding processing, the control unit 510 can determine at least one group of transform domain vectors for each layer, respectively.

In addition, the control unit 510 can determine a plurality of spatial vectors, e.g., L spatial vectors, where L is a positive integer. The control unit 510 can determine the plurality of spatial domain vectors according to a conventional method of determining spatial domain vectors (for example, a method of determining spatial domain vectors specified by a wireless communication standard such as the 3GPP standard specification). In the present disclosure, spatial domain vectors can also be referred to as spatial beams, or spatial codewords, or wideband codewords, or wideband spatial domain codewords, or the like.

In the present disclosure, each spatial domain vector can have frequency domain weighting coefficients, such as the LC coefficients mentioned above. The factors associated with the plurality of spatial vectors can be frequency domain weighting coefficients of the plurality of spatial domain vectors.

Furthermore, in the present disclosure, the at least one group of transform domain vectors can be one group of transform domain vectors, or can be a plurality of groups of transform domain vectors.

In the present disclosure, the control unit 510 can autonomously determine the number of the groups of transform domain vectors. For example, the control unit 510 can determine how many groups of transform domain vectors it should determine according to the provisions of a wireless communication standard (e.g., the 3GPP standard specification). For example, a wireless communication standard (e.g., a 3GPP standard specification) can specify that the number of groups of transform domain vectors is one. Accordingly, the control unit 510 determines one group of transform domain vectors.

Alternatively, the control unit 510 can determine the number of the groups of transform domain vectors by means of an indication from the base station. In this case, the base station can indicate to the terminal the number of the groups of transform domain vectors or a value range of the number of the groups of transform domain vectors.

For example, in an example where the base station indicates to the terminal the number of the groups of transform domain vectors, the terminal 500 can further include: a receiving unit 530. The receiving unit 530 can be configured to receive indication information from the base station that is used to indicate the number of the at least one group of transform domain vectors. In this example, the control unit 510 can determine at least one group of transform domain vectors corresponding to the number. For example, the number of the at least one group of transform domain vectors indicated by the indication information is one, and accordingly, the control unit 510 can determine one group of transform domain vectors. For another example, the number of the at least one group of transform domain vectors indicated by the indication information is L (i.e., the same as the number of the plurality of spatial domain vectors), and accordingly, the control unit 510 can determine L groups of transform domain vectors.

For another example, in an example where the base station indicates to the terminal the value range of the number of the groups of transform domain vectors, the receiving unit 530 can receive indication information from the base station that is used to indicate whether the number of the at least one group of transform domain vectors is greater than the preset threshold. When the indication information indicates that the number of the at least one group of transform domain vectors is greater than the preset threshold, the control unit 510 can determine a plurality of groups of transform domain vectors. The number of the plurality of groups of transform domain vectors can be the same as the number of the plurality of spatial domain vectors, or can be greater than the number of the plurality of spatial domain vectors (e.g., twice the number of the plurality of spatial domain vectors). When the indication information indicates that the number of the at least one group of transform domain vectors is smaller than the preset threshold, the control unit 510 can determine one group of transform domain vectors. For example, the preset threshold can be 2, and when the indication information indicates that the number of the at least one group of transform domain vectors is greater than 2, the control unit 510 can determine L groups of transform domain vectors, and when the indication information indicates the number of the at least one group of transform domain vectors is less than 2, the control unit 510 can determine one group of transform domain vectors.

In the present disclosure, when the at least one group of transform domain vectors is one group of transform domain vectors, the group of transform domain vectors is used to process factors associated with each spatial domain vector of the plurality of spatial domain vectors. For example, in an example where the factors are frequency domain weighting coefficients and the processing is compressing, the group of transform domain vectors can be used to compress the frequency domain weighting coefficients for each spatial domain vector of the plurality of spatial domain vectors. That is, for each spatial vector of the plurality of spatial vectors, the group of transform domain vectors is common.

In addition, when the at least one group of transform domain vectors is a plurality of groups of transform domain vectors, the number of the plurality of groups of transform domain vectors can be the same as the number of the plurality of spatial domain vectors, and each group of transform domain vectors of the plurality of groups of transform domain vectors is respectively used to process factors associated with respective spatial domain vector of the plurality of spatial domain vectors. For example, in an example where the factors are frequency domain weighting coefficients and the processing is compressing, each group of transform domain vectors of the plurality of groups of transform-domain vectors is respectively used to compress the frequency domain weighting coefficients of respective spatial domain vectors of the plurality of spatial domain vectors. For example, the number of the plurality of groups of transform domain vectors can be L, and the plurality of groups of transform domain vectors are respectively a first group of transform domain vectors, a second group of transform domain vectors, . . . , the Lth group of transform domain vectors, and the first group of transform domain vectors is used to compress the frequency domain weighting coefficients of the first spatial domain vector of the plurality of spatial domain vectors, the second group of transform domain vectors is used to compress the frequency domain weighting coefficients of the second spatial domain vector of the plurality of spatial domain vectors, . . . , the Lth group of transform domain vectors is used to compress the frequency domain weighting coefficients of the Lth spatial domain vector of the plurality of spatial domain vectors. That is, for each spatial vector of the plurality of spatial vectors, the group of transform domain vectors is specific. This circumstance is applicable to the situation where the base station adopts a single-polarized antenna.

Furthermore, when the at least one group of transform domain vectors is a plurality of groups of transform domain vectors, the number of the plurality of groups of transform domain vectors can be greater than the number of the plurality of spatial domain vectors, and each group of transform domain vectors of the plurality of groups of transform domain vectors is respectively used to process factors associated with respective spatial domain vector of the plurality of spatial domain vectors. For example, the number of the plurality of groups of transform domain vectors can be twice the number of the plurality of spatial domain vectors. This circumstance is applicable to the situation where the base station adopts dual-polarized antennas.

Furthermore, the control unit 510 can determine the at least one group of transform domain vectors from candidate transform domain vectors with respect to the precoding matrix. Each group of transform domain vectors can include a plurality of transform domain vectors. For example, each group of transform domain vectors can include Mᵥ transform domain vectors, where Mᵥ is a positive integer, and v represents a rank corresponding to the terminal and is a positive integer.

A schematic process of control unit 510 determining one group of transform domain vectors from the candidate transform domain vectors will be described below.

First, the receiving unit 530 can receive fourth information used to indicate a first parameter from the base station, where the first parameter represents the number of the candidate transform domain vectors with respect to the precoding matrix.

According to an example of the present disclosure, the fourth information can include the first parameter. For example, the fourth information can include only the first parameter, i.e., the fourth information is the first parameter. For another example, the fourth information can include not only the first parameter, but also other information (e.g., other configuration information transmitted by the base station to the terminal).

In addition, according to an example of the present disclosure, the fourth information can also be used to indicate a value range of the first parameter. In this example, the terminal can determine the value range of the first parameter according to the fourth information, and select a value from the value range, and use the selected value as the value of the first parameter.

In addition, the first parameter can be denoted as Mₘₐₓ, of which the value is smaller than the number of subcarriers of the communication system (e.g., can be denoted as N₃) and greater than the number of subbands of the communication system (e.g., can be denoted as N₀). Alternatively, the value of the first parameter can be smaller than the number (N₃) of the subcarriers of the communication system and smaller than the number (N₀) of the subbands of the communication system.

In addition, the base station can transmit the fourth information to the terminal via higher layer signaling. In an example where the higher-layer signaling is Radio Resource Control (RRC) signaling or Media Access Control (MAC) Control Element (CE), the base station can transmit the fourth information to the terminal via RRC signaling or MAC CE. Accordingly, the receiving unit 530 can receive the fourth information from the base station via RRC signaling or MAC CE.

In addition, the base station can transmit the fourth information to the terminal via lower layer signaling. In an example where the lower layer signaling is Downlink Control Information (DCI), the base station can transmit the fourth information to the terminal via the DCI. Accordingly, the receiving unit 530 can receive the fourth information from the base station via DCI.

Then, the control unit 510 can determine one group of transform domain vectors from the number of the candidate transform domain vectors indicated by the fourth information. The group of transform domain vectors includes a plurality of transform domain vectors, for example, includes Mᵥ transform domain vectors, where Mᵥ is a positive integer, and v represents a rank corresponding to the terminal and is a positive integer.

When the value of the first parameter indicated by the fourth information is small, that is, when the number (Mₘₐₓ) of the candidate transform domain vectors with respect to the precoding matrix is relatively small, the control unit 510 can directly select Mᵥ transform domain vectors from the Mmax candidate transform domain vectors. When the value of the first parameter indicated by the fourth information is relatively large, that is, when the number (Mₘₐₓ) of the candidate transform domain vectors with respect to the precoding matrix is relatively large, the control unit 510 can determine the Intermediate Subset (which can be abbreviated as InS or subset) of the candidate transform domain vectors, and select Mᵥ transform domain vectors from the subset to further reduce the feedback overhead.

In an example where the control unit 510 selects Mᵥ transform domain vectors from the subset, the control unit 510 can determine at least one group of transform domain vectors from the subset of the candidate transform domain vectors with respect to the precoding matrix according at least on to the second parameter. When the at least one group of transform domain vectors is one group of transform domain vectors and the group of transform domain vectors includes Mᵥ transform domain vectors, the control unit 510 can determine Mᵥ transform domain vectors from the subset of the candidate transform domain vectors with respect to the precoding matrix according to the second parameter. The second parameter can be a parameter used to determine the vectors included in the subset of the candidate transform domain vectors, which can be denoted as Mᵢₙᵢₜᵢₐₗ. The value range of the second parameter can be specified by a wireless communication standard specification (eg, a 3 GPP standard specification). For example, the value range of the second parameter can be: Mᵢₙᵢₜᵢₐₗ∈{−N₃′+1,−N₃′+2, . . . ,0}, where N₃′ represents the number of vectors included in the subset (InS) of the candidate transform domain vectors (also referred to the size of the subset).

The terminal and the base station can negotiate the value of the third parameter (N₃′) and the value of the fourth parameter (Mᵢₙᵢₜᵢₐₗ) in advance. According to the first example of the present disclosure, the terminal can determine the value of the third parameter and the value of the fourth parameter, and report the value of the third parameter and the value of the fourth parameter determined by itself to the base station. According to the second example of the present disclosure, the base station can determine the value of the third parameter and the value of the fourth parameter, and notify the terminal of the value of the third parameter and the value of the fourth parameter determined by itself. According to the third example of the present disclosure, the terminal can determine the value of the third parameter and report the value of the third parameter determined by itself to the base station, and the base station can determine the value of the fourth parameter and report the value of the fourth parameter determined by itself to the terminal. According to the fourth example of the present disclosure, the base station can determine the value of the third parameter and notify the terminal of the value of the third parameter determined by itself, and the terminal can determine the value of the fourth parameter and report the value of the fourth parameter determined by itself to the base station.

In addition, in the present disclosure, the transmitting unit 520 transmits precoding matrix indication information to the base station, where the precoding matrix indication information includes first information that is used to indicate at least one group of transform domain vectors. For example, the first information can be used to indicate the indexes of the at least one group of transform domain vectors. For example, for any group of transform domain vectors selected from the candidate transform domain vectors, an index can be preset. Accordingly, when the control unit 510 determines the at least one group of transform domain vectors, the first information can indicate the indexes of the at least one group of transform domain vectors.

In addition, according to an example of the present disclosure, the precoding matrix indication information can further include second information. The second information can be used to indicate a parameter used to determine the at least one group of transform domain vectors. The parameter is used to determine the at least one group of transform domain vectors from the candidate transform domain vectors with respect to the precoding matrix. For example, the parameter can be the first parameter (Mₘₐₓ) described above, which represents the number of the candidate transform domain vectors with respect to the precoding matrix. As another example, the parameter can be the second parameter (Mᵢₙᵢₜᵢₐₗ) described above which is used to determine the at least one group of transform domain vectors from the subset of the candidate transform domain vectors with respect to the precoding matrix.

In addition, according to an example of the present disclosure, the precoding matrix indication information can further include third information. The third information can be used to indicate the plurality of spatial domain vectors mentioned above. For example, the third information can be used to indicate the indexes of the plurality of spatial domain vectors mentioned above.

Furthermore, as described above, the control unit 510 can process the factors associated with the plurality of spatial domain vectors using the at least one group of transform domain vectors to obtain processed factors. According to an example of the present disclosure, the precoding matrix indication information can further include the processed factors. In an example where the factors are a frequency domain weighting coefficients and the processing is compressing, the precoding matrix indication information can further include the compressed frequency domain weighting coefficients.

Furthermore, as described above, the control unit 510 can determine the plurality of spatial domain vectors and the at least one group of transform domain vectors for each layer corresponding to the precoding processing. When the value of the rank corresponding to the terminal is 1, the layer corresponding to the precoding process is one layer (that is, the number of layers and the value of the rank can be the same), therefore, the control unit 510 can determine the plurality of spatial domain vectors and the at least one group of transform domain vectors. Accordingly, the precoding matrix indication information can include first information and second information corresponding to the at least one group of transform domain vectors, and third information corresponding to the plurality of spatial domain vectors. When the value of the rank corresponding to the terminal is greater than 1, the layer corresponding to the precoding process includes a plurality of layers (the number of the plurality of layers can be the same as the value of the rank), therefore, the control unit 510 can respectively determine the plurality of spatial domain vectors and the at least one group of transform domain vectors for each layer. Accordingly, the precoding matrix indication information can include first information and second information corresponding to the at least one group of transform domain vectors for each layer, and third information corresponding to the plurality of spatial domain vectors for each layer. That is, the precoding matrix indication information can include a plurality of first information, a plurality of second information, and a plurality of third information. In addition, according to an example of the present disclosure, the plurality of spatial vectors determined by the control unit 510 for each layer can be the same. In this case, the precoding matrix indication information can include a plurality of first information, a plurality of second information and a third message.

Furthermore, in an example where the control unit 510 determines the at least one group of transform domain vectors from the subset of the candidate transform domain vectors, when the control unit 510 determines at least one group of transform domain vectors for different layers, respectively, the control unit 510 can determine different subsets according to different values of the second parameters, so that the at least one group of transform domain vectors for each layer is determined from the different subsets. For example, when the control unit 510 is set to determine at least one group of transform domain vectors for the first layer and the second layer, respectively, the control unit 510 can determine the first subset according to the first value of the second parameter, and determine the at least one group of transform domain vectors for the first layer from the first subset, and determine a second subset according to the second value of the second parameter, and determine the at least one group of transform domain vectors for the second layer from the second subset.

Furthermore, in addition to the first information, second information, third information, and so forth mentioned above, the precoding matrix indication information can also include other information. Such information can be information specified by a wireless communication standard (e.g., the 3GPP standard specification), for example, amplitude coefficient indicators, phase coefficient indicators, and so forth for each layer.

According to an example of the present disclosure, the precoding matrix indication information can be Precoding Matrix Indicator (PMI). A specific example of PMI is given below. The value of PMI can correspond to indexes i₁ and i₂ of codebook, where

$${i}_{1} = \{ \begin{matrix}[ {i}_{1 , 1} {i}_{1 , 2} {i}_{1 , 5} {i}_{1 , 6 , 1} {i}_{1 , 7 , 1} {i}_{1 , 8 , 1} ] & v = 1 \\ [ {i}_{1 , 1} {i}_{1 , 2} {i}_{1 , 5} {i}_{1 , 6 , 1} {i}_{1 , 7 , 1} {i}_{1 , 8 , 1} … {i}_{1 , 6 , v} {i}_{1 , 7 , v} {i}_{1 , 8 , v} ] & v > 1\end{matrix}$$

$${i}_{2} = \{ \begin{matrix}[ {i}_{2 , 3 , 1} {i}_{2 , 4 , 1} {i}_{2 , 5 , 1} ] & v = 1 \\ [ {i}_{2 , 3 , 1} {i}_{2 , 4 , 1} {i}_{2 , 5 , 1} … {i}_{2 , 3 , v} {i}_{2 , 4 , v} {i}_{2 , 5 , v} ] & v > 1\end{matrix}$$

Wherein, i_{1,1} and i_{1,2} indicate the indexes of the plurality of spatial vectors, and i_{1,5} indicates at least one value of the first parameter (Mₘₐₓ) and/or at least one value of the second parameter (Mᵢₙᵢₜᵢₐₗ) (alternatively, indicates the index of the at least one value of the first parameter and/or the index of the at least one value of the second parameter), i_{1,6,l} indicates the index of the at least one group of transform domain vectors for the lth layer, 1≤l≤v and l is a positive integer, v is the rank corresponding to the terminal and is a positive integer greater than or equal to 1. The definition of the remaining elements can follow the provisions of a wireless communication standard, for example, i_{2,3,l} and i_{2,4,l} can be the amplitude coefficient indicators for the lth layer, and i_{2,5,l} can be the phase coefficient indicator for the lth layer.

With the terminal of an embodiment of the present disclosure, in the case where the communication system applies the subcarrier-level precoding technology, the terminal can determine at least one group of transform domain vectors for processing factors associated with a plurality of spatial domain vectors, and include the at least one group of transform domain vectors in the precoding matrix indication information, and feed the precoding matrix indication information back to the base station, so that the base station determines the subcarrier-level precoding matrix according to the precoding matrix indication information.

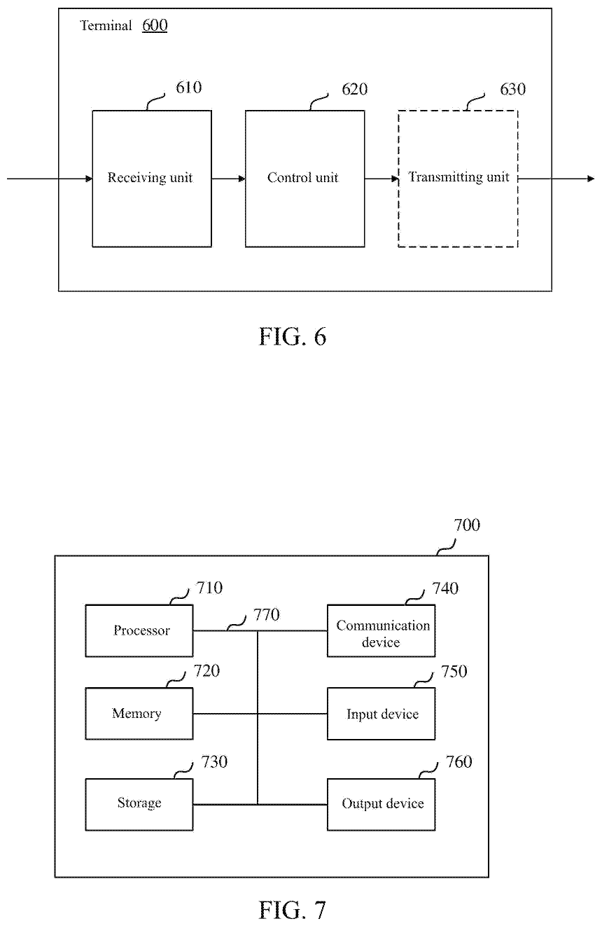

Hereinafter, a base station according to an embodiment of the present disclosure will be described with reference to FIG. 6. FIG. 6 is a schematic structural diagram of a base station 600 according to an embodiment of the present disclosure. Since the functions of the base station 600 are the same as some details of the method 400 described above with reference to FIG. 4, a detailed description of the same is omitted for simplicity. As shown in FIG. 6, the base station 600 includes: a receiving unit 610 configured to receive precoding matrix indication information from the terminal, where the precoding matrix indication information includes at least first information that is used to indicate the at least one group of transform domain vectors; and a control unit 620, configured to determine a precoding matrix according to the precoding matrix indication information. In addition to the two units, the base station 600 can also include other components, however, since these components are not related to the content of the embodiments of the present disclosure, their illustrations and descriptions are omitted here.

In the present disclosure, at least one group of transform domain vectors can be one group of transform domain vectors, or can be a plurality of groups of transform domain vectors. The base station can indicate to the terminal the number of the groups of transform domain vectors or the value range of the number of the groups of transform domain vectors, so that the terminal can determine how many groups of transform domain vectors it should determine by means of the indication of the base station.

For example, in an example where the base station indicates to the terminal the number of the groups of transform domain vectors, the base station 600 can further include: a transmitting unit 630. The transmitting unit 630 is configured to transmit indication information to the terminal that is used to indicate the number of the at least one group of transform domain vectors. In this example, the terminal can determine at least one group of transform domain vectors corresponding to the number. For example, the number of the at least one group of transform domain vectors indicated by the indication information is one, and accordingly, the terminal can determine one group of transform domain vectors. For another example, the number of the at least one group of transform domain vectors indicated by the indication information is L (i.e., the same as the number of the plurality of spatial domain vectors), and accordingly, the terminal can determine L groups of transform domain vectors.

For another example, in an example where the base station indicates to the terminal the value range of the number of the groups of transform domain vectors, the transmitting unit 630 can be configured to transmit indication information to the terminal that is used to indicate whether the number of the at least one group of transform domain vectors is greater than the preset threshold. When the indication information indicates that the number of the at least one group of transform domain vectors is greater than the preset threshold, the terminal can determine a plurality of groups of transform domain vectors. The number of the plurality of groups of transform domain vectors can be the same as the number of a plurality of spatial domain vectors, or can be greater than the number of the plurality of spatial domain vectors (e.g., twice the number of the plurality of spatial domain vectors). When the indication information indicates that the number of the at least one group of transform domain vectors is less than the preset threshold, the terminal can determine one group of transform domain vectors. For example, the preset threshold can be 2, and when the indication information indicates that the number of the at least one group of transform domain vectors is greater than 2, the terminal can determine L groups of transform domain vectors, and when the indication information indicates the number of the at least one group of transform domain vectors is less than 2, the terminal can determine one group of transform domain vectors.

In addition, according to an example of the present disclosure, the precoding matrix indication information can further include second information. The second information can be used to indicate a parameter for determining the at least one group of transform domain vectors. The parameter is used to determine the at least one group of transform domain vectors from candidate transform domain vectors with respect to the precoding matrix. For example, the parameter can be the first parameter (Mₘₐₓ) described above, which represents the number of the candidate transform domain vectors with respect to the precoding matrix. As another example, the parameter can be the second parameter (Mᵢₙᵢₜᵢₐₗ) described above, which is used to determine the at least one group of transform domain vectors from the subset of the candidate transform domain vectors with respect to the precoding matrix.

In addition, according to an example of the present disclosure, the precoding matrix indication information can further include third information. The third information can be used to indicate the plurality of spatial vectors determined by the terminal. For example, the third information can be used to indicate indexes of the plurality of spatial vectors determined by the terminal.

Furthermore, as described above, the terminal can process the factors associated with the plurality of spatial domain vectors using the at least one group of transform domain vectors to obtain processed factors. According to an example of the present disclosure, the precoding matrix indication information can further include the processed factors. In an example where the factors are frequency-domain weighting coefficients and the processing is compressing, the precoding matrix indication information can further include the compressed frequency domain weighting coefficients.

In addition, in addition to the first information, second information, and third information, and so forth mentioned above, the precoding matrix indication information can also include other information. Such information can be information specified by a wireless communication standard (e.g., the 3GPP standard specification), for example, amplitude coefficient indicator, phase coefficient indicator, and so forth for each layer.

According to an example of the present disclosure, the precoding matrix indication information can be Precoding Matrix Indicator (PMI).

In addition, in the present disclosure, the control unit 620 determines the precoding matrix according to the precoding matrix indication information. For example, in an example where the precoding matrix indication information is PMI, the control unit 620 can generate the precoding matrix according to a conventional manner of generating a precoding matrix through PMI (e.g., the manner prescribed by the 3GPP standard specification).

With the base station of the embodiment of the present disclosure, in the case where the communication system applies the subcarrier-level precoding technology, the terminal can determine the at least one group of transform domain vectors for processing factors associated with a plurality of spatial domain vectors, and include the at least group set of transform domain vectors in the precoding matrix indication information, and feed the precoding matrix indication information back to the base station. Accordingly, the base station can receive the precoding matrix indication information from the terminal and determine the subcarrier-level according to the precoding matrix indication information.

(Hardware Structure)

In addition, the block diagrams used in the description of the above-described embodiments show blocks in units of function. These functional blocks (structural units) are implemented by any combination of hardware and/or software. In addition, the implementation of each functional block is not specifically limited. That is, each functional block can be implemented by one device that is physically and/or logically combined, or by two or more devices through connecting directly and/or indirectly (for example, by wired and/or wireless) the two or more devices that are physically and/or logically separated.

For example, the communication device (such as the terminal 500 and the base station 600) of the embodiment of the present disclosure can function as a computer that executes the processing of the wireless communication method of the present disclosure. FIG. 7 is a schematic diagram of a hardware structure of a communication device 700 (terminal or base station) involved according to an embodiment of the present disclosure. The communication device 700 described above can be configured as a computer device that physically includes a processor 710, a memory 720, a storage 730, a communication device 740, an input device 750, an output device 760, a bus 770, and the like.

In addition, in the following description, the word “device” can be replaced with a circuit, a device, a unit, or the like. The hardware structures of the user terminal and the base station can include various devices shown in one or more figures, or can not include some devices.

For example, only one processor 710 is shown, but there can be multiple processors. Furthermore, processing can be performed by one processor, or by more than one processor simultaneously, sequentially, or in other ways. Additionally, the processor 710 can be installed by more than one chip.

Each function of the device 700 is implemented, for example, by reading the predetermined software (programs) into the hardware such as the processor 710 and the memory 720 to cause the processor 710 to perform execution and to control communication by the communication device 740, and control the reading and/or writing of data in the memory 720 and the storage 730.

The processor 710 operates, for example, an operating system to control the entire computer. The processor 710 can consist of a central processing unit (CPU) including an interface with peripheral devices, a control device, an arithmetic device, a register, and the like. For example, the above-mentioned determination unit, adjustment unit, and so forth can be implemented by the processor 710.

Further, the processor 710 reads out programs (program codes), software modules, data, and so forth from the storage 730 and/or the communication device 740 to the memory 720, and executes various processes according to them. As the program, a program for causing a computer to execute at least a part of the operations described in the above-described embodiments can be adopted. For example, the control unit of the terminal 500 can be implemented by a control program stored in the memory 720 and operated by the processor 710, and for other functional blocks, they can also be implemented similarly.

The memory 720 is a computer-readable recording medium and for example, can consist of at least one of Read Only Memory (ROM), Erasable Programmable ROM (EPROM), Electrically EPROM (EEPROM), Random Access Memory (RAM) and other suitable storage media. Memory 720 can also be referred to as registers, cache, main memory (main storage), and the like. The memory 720 can store executable programs (program codes), software modules, and the like for implementing the method related to an embodiment of the present disclosure.

The storage 730 is a computer-readable recording medium, and for example, can consist of at least one of a flexible disk, a Floppy® disk (registered trademark), a magnetic disk (for example, Compact Disc ROM (CD-ROM), and so forth), Digital versatile discs, Blu-ray® discs, removable disks, hard drives, smart cards, flash memory devices (e.g., cards, sticks, key drivers), magnetic stripes, databases, servers, and other suitable storage media. storage 730 can also be referred to as secondary storage.

The communication device 740 is a hardware (transmitting and receiving device) used for communication between computers through a wired and/or wireless network, and is also referred to, for example, a network device, a network controller, a network card, a communication module, and the like. The communication device 740 can include a high-frequency switch, a duplexer, a filter, a frequency synthesizer, and the like in order to achieve, for example, Frequency Division Duplex (FDD) and/or Time Division Duplex (TDD). For example, the transmitting unit, the receiving unit, and so forth of the above-mentioned terminal 500 can be implemented by the communication device 740.

The input device 750 is an input device (e.g., keyboard, mouse, microphone, switch, button, sensor, and so forth) that accepts input from the outside. The output device 760 is an output device (e.g., a display, a speaker, a Light Emitting Diode (LED) lamp, and so forth) that outputs to the outside. In addition, the input device 750 and the output device 760 can also have an integrated structure (e.g., a touch panel).

In addition, various devices such as the processor 710 and the memory 720 are connected by a bus 770 for communication. The bus 770 can consist of a single bus, or can consist of different buses between devices.

In addition, the base station and the terminal can include a microprocessor, a Digital Signal Processor (DSP), an Application Specific Integrated Circuit (ASIC), a Programmable Logic Device (PLD), a Field Programmable Gate Array (FPGA) and other hardware can be used to realize part or all of various functional blocks. For example, the processor 710 can be installed by at least one of these pieces of hardware.

(Variation)

In addition, the terms described in this specification and/or terms necessary for understanding this specification can be interchanged with terms having the same or similar meanings. For example, channels and/or symbols can also be signals (signaling). In addition, signals can also be messages. The reference signal can also be referred to as an RS for short, and can also be referred to as a pilot, a pilot signal, or the like according to the applicable standard. In addition, a component carrier (CC) can also be referred to as a cell, a frequency carrier, a carrier frequency, or the like.

In addition, the information, parameters, and so forth described in this specification can be expressed by absolute values, can be expressed by relative values with respect to predetermined values, or can be expressed by corresponding other information. For example, the radio resource can be indicated by a predetermined index. Further, the formulas and the like using these parameters can also be different from those explicitly disclosed in this specification.

The names used for parameters and the like in this specification are not intended to be limiting in any way. For example, various channels (Physical Uplink Control Channel (PUCCH), Physical Downlink Control Channel (PDCCH), and so forth) and information elements can be identified by any suitable names, and thus the various names assigned to these various channels and information elements, are in no way limiting.

The information, signals, and so forth described in this specification can be represented using any of various different technologies. For example, data, commands, instructions, information, signals, bits, symbols, chips, and so forth that can be mentioned throughout the above description can be represented by voltages, currents, electromagnetic waves, magnetic fields or magnetic particles, light fields or photons, or any combination thereof.

In addition, information, signals, and so forth can be output from the upper layer to the lower layer, and/or from the lower layer to the upper layer. Information, signals, and so forth can be input or output via multiple network nodes.

Input or output information, signals, and so forth can be stored in a specific place (e.g., memory), and can also be managed through a management table. Input or output information, signals, and so forth can be overwritten, updated or supplemented. Output information, signals, and so forth can be deleted. Input information, signals, and so forth can be transmitted to other devices.

Notification of information is not limited to the manner/embodiment described in this specification, and can be performed by other methods. For example, the notification of information can be through physical layer signaling (e.g., Downlink Control Information (DCI), Uplink Control Information (UCI)), upper layer signaling (e.g., Radio Resource Control Information (RRC) signaling, broadcast information (Master Information Block (MIB), System Information Block (SIB), and so forth), Medium Access Control (MAC) signaling), other signals, or a combination thereof.

In addition, the physical layer signaling can also be referred to as L1/L2 (Layer 1/Layer 2) control information (L1/L2 control signal), L1 control information (L1 control signal), or the like. In addition, the RRC signaling can also be referred to as an RRC message, for example, an RRC connection setup message, an RRC connection reconfiguration message, and the like. In addition, the MAC signaling can be notified by, for example, a MAC control element (MAC CE).

In addition, notification of specified information (e.g., notification of “is X”) is not limited to being performed explicitly, and can be performed implicitly (e.g., by not performing notification of the predetermined information, or by notification of other information).

The determination can be performed by a value (0 or 1) represented by 1 bit, or by a true or false value (Boolean value) represented by true or false, or by a numerical comparison (e.g., a comparison with a predetermined value) is performed.

Whether software is referred to as software, firmware, middleware, microcode, hardware description language, or by other names, it should be construed broadly to mean commands, instruction sets, codes, code segments, program codes, programs, subprograms, software modules, applications, software applications, software packages, routines, subroutines, objects, executable files, threads of execution, steps, functions, and so forth

Also, software, commands, information, and so forth can be transmitted or received via a transmission medium. For example, when transmitting software from a website, server, or other remote source using wireline technology (coaxial cable, fiber optic cable, twisted pair, Digital Subscriber Line (DSL), and so forth) and/or wireless technology (infrared, microwave, and so forth), these wired and/or wireless technologies are included within the definition of transmission medium.

The terms “system” and “network” are used interchangeably in this specification.

In this specification, terms such as “base station (BS)”, “wireless base station”, “eNB”, “gNB”, “cell”, “sector”, “cell group”, “carrier” and “component carrier” are used interchangeably. The base station is sometimes referred to terms such as fixed station, NodeB, eNodeB (eNB), access point, transmission point, reception point, femtocell, and small cell.

A base station can accommodate one or more (e.g., three) cells (also referred to as sectors). When the base station accommodates multiple cells, the entire coverage area of the base station can be divided into multiple smaller areas, and various smaller areas can also provide communication service through the subsystem of the base station (for example, indoor small base stations (Remote Radio Heads (RRH)). The terms such as “cell” or “sector” refer to a portion or the entirety of the coverage area of the base station and/or the subsystem of the base station in which the communication service is performed.

In this specification, the terms such as “mobile station (MS)”, “user terminal”, “user equipment (UE)”, and “terminal” are used interchangeably. A mobile station is also sometimes referred to by those skilled in the art as subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, or some other appropriate term.

In addition, the base station in this specification can also be replaced with a terminal. For example, various modes/embodiments of the present disclosure can also be applied to a structure in which communication between a base station and a terminal is replaced by communication between a plurality of terminals (D2D, Device-to-Device). In this case, the functions possessed by the base station 600 can be regarded as functions possessed by the terminal. In addition, words such as “up” and “down” can also be replaced by “side”. For example, the upstream channel can also be replaced by a side channel.

Likewise, the terminal in this specification can also be replaced with a base station. In this case, the functions possessed by the terminal 500 described above can be regarded as functions possessed by the base station.

In this specification, it is assumed that a specific operation performed by a base station is also performed by an upper node in some cases. Obviously, in a network composed of one or more network nodes with base stations, various operations performed for communication between terminals can be performed through the base station, more than one network other than the base station (for example, Mobility Management Entity (MME), Serving-Gateway (S-GW), and so forth can be considered, but not limited thereto), or a combination thereof.

Various aspects/embodiments described in this specification can be used alone, can be used in combination, and can be used by switching during execution. In addition, as long as there is no contradiction in the processing procedure, sequence, flowchart, and so forth of each aspect/embodiment described in this specification, the order can be changed. For example, with respect to the methods described in this specification, various step units are presented in an exemplary order and are not limited to the specific order presented.

The various modes/embodiments described in this specification can be applied to applications utilizing Long Term Evolution (LTE), LTE-Advanced (LTE-A), LTE-Beyond (LTE-B), Super 3rd generation mobile communication system (SUPER 3G), Advanced International Mobile Telecommunications (IMT-Advanced), 4th generation mobile communication system (4G), 5th generation mobile communication system (5G), 6th generation mobile communication system (6G), future radio access (FRA), new radio access technology (New-RAT), new radio (NR), New Radio Access (NX), Future Generation Radio Access (FX), Global System for Mobile Communications (GSM®), Code Division Multiple Access 3000 (CDMA3000), Ultra Mobile Broadband (UMB), IEEE 920.11 (Wi-Fi®), IEEE 920.16 (WiMAX®), IEEE 920.20, Ultra Wideband (UWB), Bluetooth®, other suitable wireless communication method systems and/or next-generation systems extended based on them.

The description such as “according to” used in this specification does not mean “according only to” unless it is explicitly stated in other paragraphs. In other words, the description of “according to” means both “according only to” and “according at least to”.

Any reference in this specification to an element using the designation “first”, “second” and so forth is not intended to comprehensively limit the number or order of such elements. These expressions can be used in this specification as a convenient method for distinguishing two or more units. Thus, a reference to a first unit and a second unit does not imply that only two units can be employed or that the first unit must precede the second unit in some form.

The term “determining” used in this specification can include various operations. For example, regarding “determining”, calculating, computing, processing, deriving, investigating, looking up (e.g., looking up in tables, databases, or other the data structure), ascertaining, and so forth are regarded as “determination”. In addition, regarding “determining”, receiving (for example, receiving information), transmitting (for example, transmitting information), input, output, accessing (for example, access to data in the memory), and so forth, are also regarded as “determining”. In addition, regarding “determining”, resolving, selecting, choosing, establishing, comparing, and so forth can also be regarded as “determining”. That is, regarding “determining”, several actions can be regarded as “determining”.

The terms such as “connected”, “coupled” or any of their variants used in this specification refer to any connection or combination, direct or indirect, between two or more units, which can include the following situations: between two units that are “connected” or “coupled” with each other, there are one or more intermediate units. The coupling or connection between the units can be physical or logical, or can also be a combination of the two. For example, “connecting” can also be replaced by “accessing”. As used in this specification, two units can be considered to be electrically connected through the use of one or more wires, cables, and/or printed, and as a number of non-limiting and non-exhaustive examples, and are “connected” or “coupled” with each other through the use of electromagnetic energy with wavelengths in a radio frequency region, the microwave region, and/or in the light (both visible and invisible) region, and so forth.

When used in this specification or the claims “including”, “comprising”, and variations thereof, these terms are as open ended as the term “having”. Further, the term “or” used in this specification or in the claims is not an exclusive-or.

The present disclosure has been described in detail above, but it is obvious to those skilled in the art that the present disclosure is not limited to the embodiments described in this specification. The present disclosure can be implemented as a modified and changed form without departing from the spirit and scope of the present disclosure defined by the description of the claims. Therefore, the description in this specification is for the purpose of illustration and does not have any limiting meaning to the present disclosure.

1. A terminal comprising:
a control unit, configured to determine at least one group of transform domain vectors, wherein the at least one group of transform domain vectors is used to process factors associated with a plurality of spatial domain vectors, the plurality of spatial domain vectors are used to determine a subcarrier-level precoding matrix; and
a transmitting unit, configured to transmit precoding matrix indication information to a base station, wherein the precoding matrix indication information includes first information, which is used to indicate the at least one group of transform domain vectors.

2. The terminal of claim 1, further comprises:
a receiving unit, configured to receive indication information from the base station, which is used to indicate a number of the at least one group of transform domain vectors;
wherein the control unit is configured to determine the at least one group of transform domain vectors corresponding to the number.

3. The terminal of claim 1, wherein when the at least one group of transform domain vectors is one group of transform domain vectors, the group of transform domain vectors is used to process factors associated with each spatial domain vector of the plurality of spatial domain vectors.

4. The terminal of claim 1, wherein when the at least one group of transform domain vectors is a plurality of groups of transform domain vectors, a number of the plurality of groups of transform domain vectors is the same as a number of the plurality of spatial domain vectors, and each group of transform domain vectors of the plurality of groups of transform domain vectors are respectively used to process factors associated with respective spatial domain vectors of the plurality of spatial domain vectors.

5. The terminal of claim 1, wherein the first information is used to indicate indexes of the at least one group of transform domain vectors.

6. The terminal of claim 1, wherein the precoding matrix indication information further includes second information, which is used to indicate a parameter for determining the at least one group of transform domain vectors.

7. The terminal of claim 6, wherein the parameter is used to determine the at least one group of transform domain vectors from candidate transform domain vectors with respect to the precoding matrix.

8. The terminal of claim 7, wherein the parameter is a first parameter for representing a number of the candidate transform domain vectors with respect to the precoding matrix.

9. The terminal of claim 7, wherein the parameter is a second parameter for determining the at least one group of transform domain vectors from a subset of the candidate transform domain vectors with respect to the precoding matrix.

10. A base station comprising:
a receiving unit, configured to receive precoding matrix indication information from a terminal, wherein the precoding matrix indication information at least includes first information, which is used to indicate the at least one group of transform domain vectors, the at least one group of transform domain vectors is used to process factors associated with a plurality of spatial domain vectors, the plurality of spatial domain vectors are used to determine a subcarrier level precoding matric; and
a control unit, configured to determine the subcarrier level precoding matrix according to the precoding matrix indication information.
